(19) United States
(12) Patent Application Publication
(10) Pub. No.: US 2016/0122206 A1
(43) Pub. Date: May 5, 2016

(54) SOLAR STILL COUNTERCURRENT FLOW SYSTEM AND APPARATUS

(71) Applicant: Board of Regents, The University of Texas System, Austin, TX (US)

(72) Inventors: William S. Walker, El Paso, TX (US); Adrian Saenz, Richardson, TX (US); Hillery T. Kemp, Many, LA (US); John Manford, Cloudcroft, NM (US)

(21) Appl. No.: 14/927,657

(22) Filed: Oct. 30, 2015

Related U.S. Application Data
(60) Provisional application No. 62/074,024, filed on Nov. 2, 2014.

(51) Int. Cl. C02F 1/14; C02F 1/04

(52) U.S. Cl. CPC C02F 1/14; C02F 1/043; C02F 2103/08

(57) ABSTRACT

A solar distillation system includes a solar collector located adjacent to a condenser, the condenser located at an angle with respect to the condenser. The solar distillation system further includes a 2^{nd} effect and an insulated portion located between the condenser and the 2^{nd} effect. The solar collector, the condenser, the insulated portion, and the 2^{nd} effect function to desalinate and purify saltwater or brackish water flowing through the solar distillation system.

### CROSS-REFERENCE TO PROVISIONAL APPLICATION

This patent application clams priority under 35 U.S.C. 119(e) to U.S. Provisional Patent Application Ser. No. 62/074,024, entitled “Solar Still Countercurrent Flow System and Apparatus,” which was filed on Nov. 2, 2014, the disclosure of which is incorporated herein by reference in its entirety.

### TECHNICAL FIELD

Embodiments are generally related to the field of solar distillation systems and devices.

### BACKGROUND

The global population is growing and its resource dependency is growing accordingly. More so, impoverished countries around the world have limited means to provide food and water to its inhabitants. The world has an abundance of water, however, only three percent of it is considered clean enough to drink. Desalination technology offers the potential to make use of the world's vast brackish and saline water resources.

Solar distillation is a method of purifying water by harnessing the sun's energy. It is an effective way of purifying seawater/brackish water because it can produce water as clean as 10 mg/L of total dissolved solids (TDS). However, solar stills have not been widely employed because the classic still only produces approximately 3 liters per day per square meter of solar capture. This poses a challenge since the amount of drinking water consumed per person is approximately 2 liters per day.

Additionally, as time passed, other methods of water filtration were developed. Reverse osmosis is currently the most popular method of desalinating water, but is energy intensive and has a high operating cost, making it unreasonable for insolvent regions.

FIG. 1 illustrates a schematic diagram of one example of a prior art “classic” solar distillation system 10. Solar distillation is an alternative for desalinating and sanitizing water using solar energy from the sun. FIG. 1 demonstrates the basic thermodynamic operation of a classic solar still. The function of a solar still is described as shown in FIG. 1 and includes a trough 18 that collects condensate. The classic solar still can vary geometrically from semispherical shapes to pyramids. A solar distiller functions with a basin 8 filled with water 16 that is manually or automatically fed into it. The sunlight radiation 12 strikes the bottom of the basin 8 where the water 16 is standing and solar thermal energy 12 heats the water and increases vaporization.

As the water evaporates, it leaves behind contaminants such as salt, bacteria, and other substances that compromise the water. As the water vapor 14 reaches the glass 7, heat escapes through the glass 7 leaving behind water vapor with low kinetic energy. As the air becomes saturated with moisture, water molecules begin to condense on the glass surface, which forms water droplets that travel to the trough. The trough 18 is an apparatus that collects the water droplets and empties it into a container such as a bottle. Water distillers such as system 10 can purify a wide variety of water from brackish groundwater to seawater.

FIG. 2 illustrates a schematic diagram of another prior art solar distillation system 20. The configuration depicted in FIG. 2 includes a double pane window with respect to an evaporator section and evaporator floor. An insulated wall and condenser section are also included with this configuration, which further includes condenser tubing and a condenser floor. The flow of cooling water in and out is also shown in FIG. 2 with respect to a water tank and the output of distillate.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide an improved solar distillation system.

It is another aspect of the disclosed embodiments to provide a solar distillation system that incorporates an improved cold air return duct.

The aforementioned aspects and other objectives and advantages can now be achieved as described herein. In an example embodiment, a solar distillation system can be implemented, which includes a solar collector located adjacent to a condenser, the condenser located at an angle with respect to the condenser. The solar distillation system further includes a 2^{nd} effect and an insulated portion located between the condenser and the 2^{nd} effect. The solar collector, the condenser, the insulated portion, and the 2^{nd} effect function to desalinate and purify saltwater or brackish water flowing through the solar distillation system.

A cold air return duct can be integrated into the solar distillation system to return cold air coming out of the top of the condenser to the base of an inclined thin film within the solar collector. The design of such a cold air return duct provides a natural, buoyancy-driven convection through the first effect to provide consistent and smooth airflow. This improvement results in more uniform and consistent temperature performance in the solar collector and the condenser. The flow rate can be modulated and controlled for efficient airflow through the system by one or more integrated valves. In another example embodiment, a countercurrent flow system can be integrated into the solar system without an external return duct.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of one example of a prior art “classic” solar distillation system;

FIG. 2 illustrates a schematic diagram of another prior art solar distillation system;

FIG. 3 illustrates a schematic diagram of a solar still that can be implemented in accordance with an example embodiment;

FIG. 4 illustrates a pictorial diagram depicting a cold air return duct, which can be adapted for use in accordance with an example embodiment;

FIG. 5 illustrates a water production comparison chart, in accordance with an example embodiment;

FIG. 6 illustrates a pictorial diagram of a solar collector air vent, which can be adapted for use in accordance with an example embodiment; and

FIG. 7 illustrates a graph depicting data indicative of heat loss through double pane glass, in accordance with an example embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and”, “or”, or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

On our globe today, there are regions on the earth where people have water sources, but no means of purifying it before consumption. Moreover, infrastructure in these areas limit the use of electric powered purifying methods leaving them to drink unclean water. It is, therefore, deemed necessary to ensure the unit produced be as electrically independent as possible and with a low manufacturing and implementation cost. Therefore, it is a vital part of this project to maintain low costs for it to be considered a viable solution.

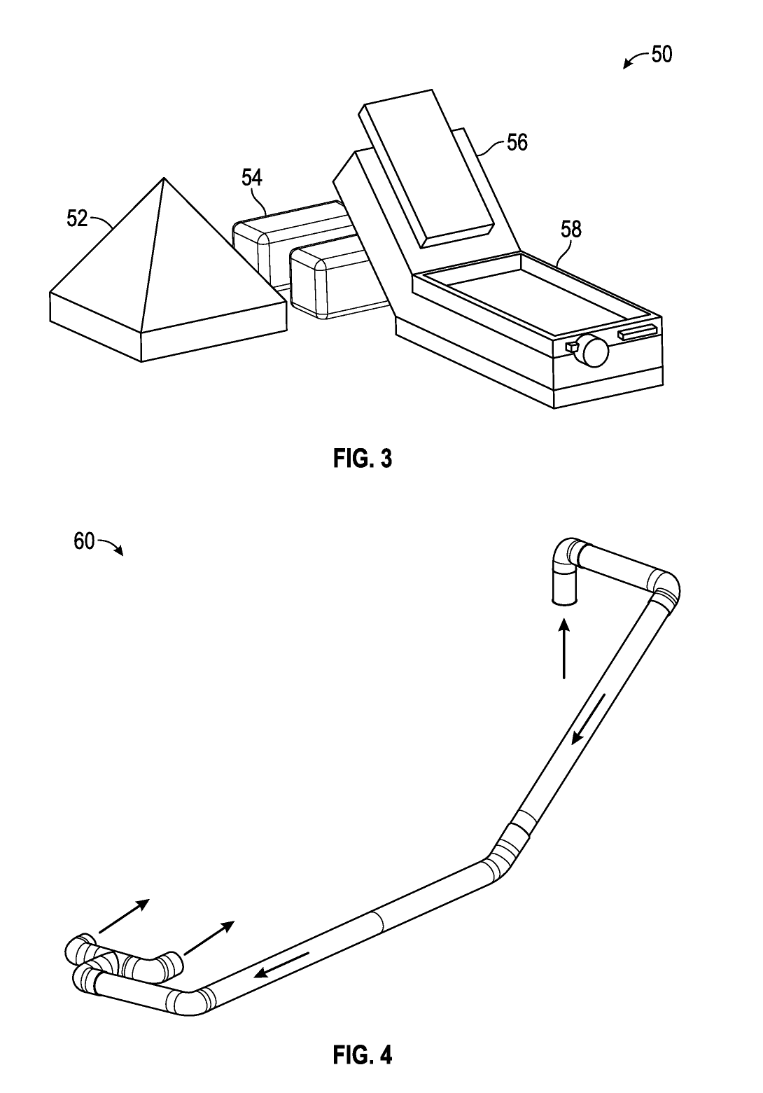

FIG. 3 illustrates a schematic diagram of a solar distillation system 50 (i.e., a solar still) that can be implemented in accordance with an example embodiment. A previous prototype was composed of two stages in series, known as “effects”. The first effect absorbs energy during the day and utilizes a heat exchanger for its condensing process. The energy gained from the heat exchanger is then transferred to the second effect as a heat source to produce evaporation for condensate during night hours. The water in the second unit loses heat during nighttime so the cooled water from the second unit is utilized again in the heat exchanger during daytime to produce condensate and the cycle repeats. This dual effect unit has shown significant advances over the standard still and yet has potential room for improvement. Hence, a 2^{nd} effect portion is shown in FIG. 3. That is, the solar distillation system 50 includes a 2^{nd} effect portion 52 with a pyramidal shape. The solar distillation system 50 also includes an insulated portion 54 with respect to a condenser 56 that is located at an angle with respect to a solar collector 58.

FIG. 4 illustrates a pictorial diagram depicting a cold air return duct 60, which can be adapted for use in accordance with an example embodiment. The cold air return duct 60 can be implemented as a PVC return duct and integrated into the system 50 shown in FIG. 3 to return cold air coming out of the top of the condenser 56 to the base of an inclined thin film within the solar collector 58. The design of the cold air return duct 60 provides a natural, buoyancy-driven convection through the first effect to provide consistent and smooth airflow. This improvement results in more uniform and consistent temperature performance in the solar collector 58 and the condenser 56. Implementation of duct 60 can improve the water production of the system by approximately 20-30%. The flow rate is modulated and controlled for efficient airflow through the system 50 by at least one integrated valve. In another example embodiment, a countercurrent flow system can be integrated into the solar system without an external PVC return duct. The disclosed advanced solar distillers improve on the classic solar still by at least a factor of 3.

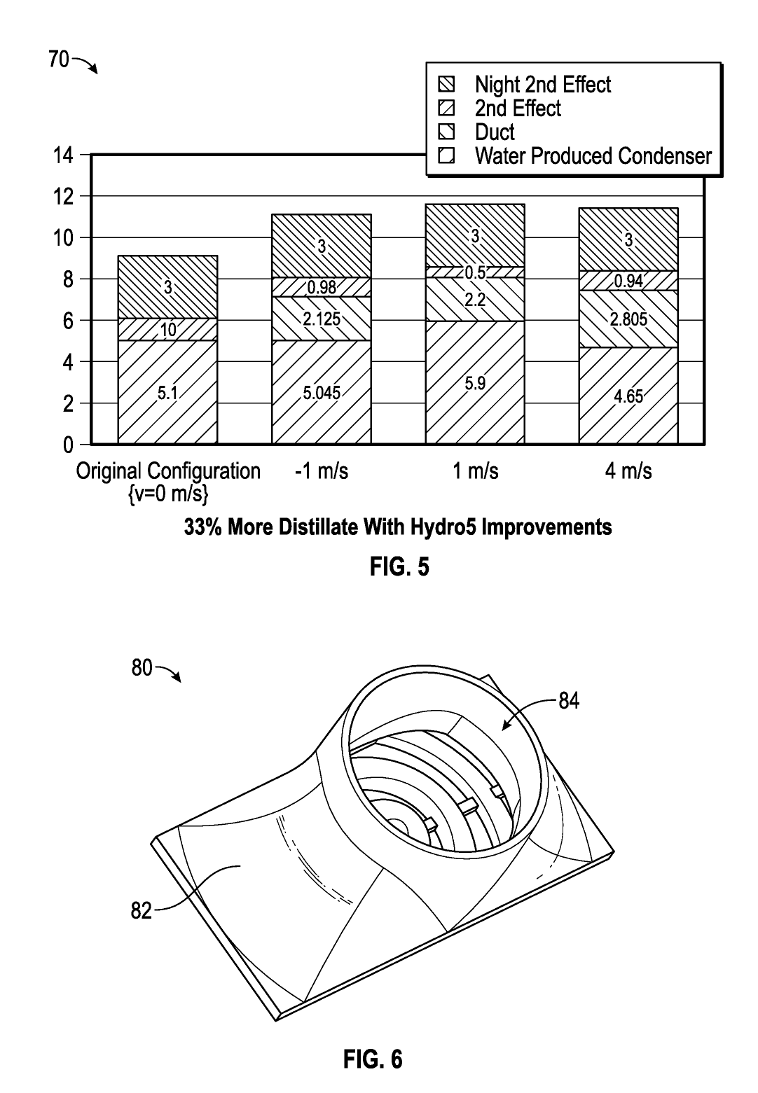

FIG. 5 illustrates a water production comparison chart 70, in accordance with an example embodiment. The water production comparison chart 70 indicates that overall the system 50 can operate with natural convection producing a maximum total distillate in a 24-hour cycle, which is an improvement approximately 30% compared to an original configuration of the prototype still.

FIG. 6 illustrates a pictorial diagram of a solar collector air vent 80, which can be adapted for use in accordance with an example embodiment. In order to improve the distribution of air from the return air duct 60 at the base of the solar collector 58, two air vents can be implemented to be placed at the end of the duct 60. The solar collector air vent 80 includes a circular opening 84 with respect to a flanged portion 82. The solar collector air vent 80 can be implemented, for example, with rapid prototyping 3-D printing. The solar collector air vent 80 can include vent foils designed to be at an angle to allow a better distribution throughout the solar collector.

In order to increase efficiency and productivity produced by the 2^{nd} effect pyramid, we implemented a black cloth to the bottom of it, so it can behave as a black body itself. By doing so the pyramid can collect more solar energy; which translates into higher temperature, humidity, and higher water production by this element alone. The amount of distillate produced before this improvement was 1 liter per square meter during the day cycle and three liters during the night cycle. With the black body floor, we were able to produce 1.5 liters per square meter during the day cycle. This is a 50% increase for the day cycle. The night cycle didn't get affected by this improvement; in both occasions we were able to produce 3 liters per square meter during the night.

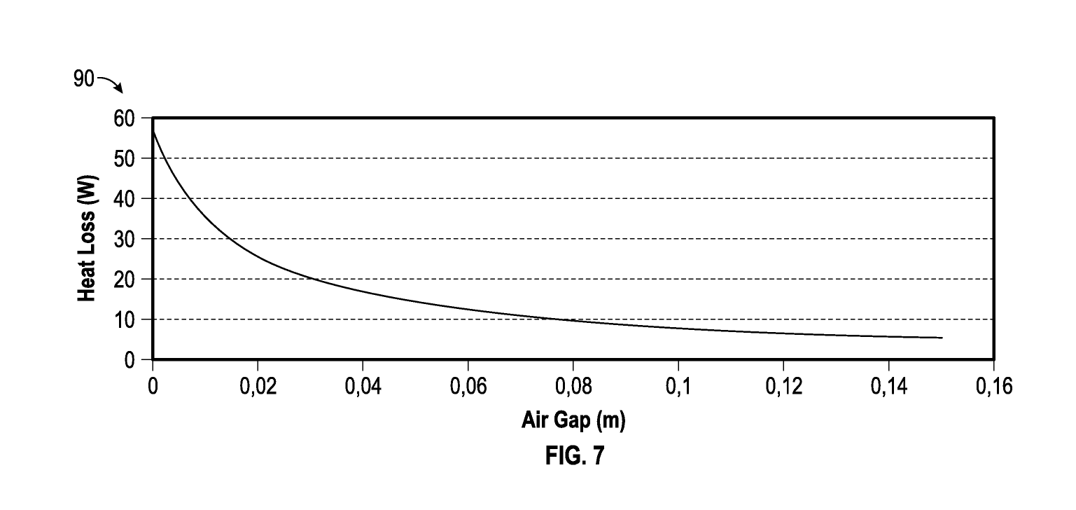

FIG. 7 illustrates a graph 90 depicting data indicative of heat loss through double pane glass, in accordance with an example embodiment. The solar collector of the first unit can be insulated utilizing a double pane glass. Solar energy passes through the glass and serves as an insulator to keep heat in. In a current example embodiment, the air gap is approximately 5 cm. Resistance modeling was used to calculate the heat loss through the double pane system, as shown in FIG. 7. The optimal air gap depends on how well the sides are insulated and how much material would be available to provide an air gap. FIG. 7 can serve as guide for further research to avoid losing energy through the solar collector.

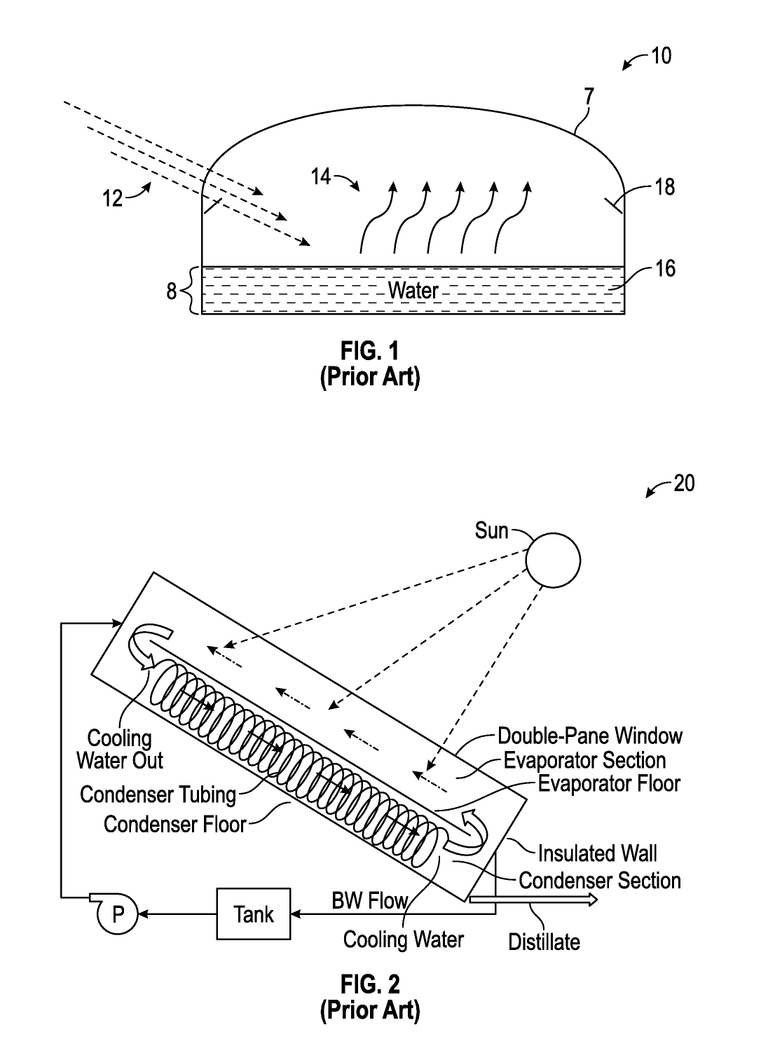

It can be appreciated that the example embodiments illustrated in FIGS. 1-7 serve only as examples to illustrate several ways of implementation of the present disclosure. Such example embodiments should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A solar distillation system, comprising:
a solar collector located adjacent to a condenser, said condenser located at an angle with respect to said condenser;
a 2^{nd} effect; and
an insulated portion located between said condenser and said 2^{nd} effect, wherein said solar collector, said condenser, said insulated portion, and said 2^{nd} effect function to desalinate and purify saltwater or brackish water flowing through said solar distillation system.

2. The solar distillation system of claim 1 further comprising a return duct that returns cold air from a top of said condenser to a base of an inclined thin film with said solar collector.

3. The solar distillation system of claim 1 wherein said 2^{nd} effect comprises a shape of a pyramid.

4. The solar distillation system of claim 1 further comprising:
a 1^{st} effect that absorbs energy during the day and utilizes a heat exchanger for a condensing process, wherein said energy gained from said heat exchanger is transferred to said 2^{nd} effect as a heat source to produce evaporation for condensate during night hours.

5. The solar distillation system of claim 4 further comprising a return duct that returns cold air from a top of said condenser to a base of an inclined thin film with said solar collector, wherein said return duct facilitates a natural, buoyancy-driven convection through said 1^{st} effect to provide consistent and smooth air flow and more uniform and consistent temperature performance in said solar collector and said condenser.

6. The solar distillation system of claim 4 further comprising a return duct that returns cold air from a top of said condenser to a base of an inclined thin film with said solar collector.

7. The solar distillation system of claim 4 wherein said 2^{nd} effect comprises a shape of a pyramid.

8. A solar distillation system, comprising:
a solar collector located adjacent to a condenser, said condenser located at an angle with respect to said condenser;
a 2^{nd} effect;
an insulated portion located between said condenser and said 2^{nd} effect, wherein said solar collector, said condenser, said insulated portion, and said 2^{nd} effect function to desalinate and purify saltwater or brackish water flowing through said solar distillation system; and
a return duct that returns cold air from a top of said condenser to a base of an inclined thin film with said solar collector.

9. The solar distillation system of claim 8 wherein said 2^{nd} effect comprises a shape of a pyramid.

10. The solar distillation system of claim 8 further comprising:
a 1^{st} effect that absorbs energy during the day and utilizes a heat exchanger for a condensing process, wherein said energy gained from said heat exchanger is transferred to said 2^{nd} effect as a heat source to produce evaporation for condensate during night hours.
